(19) United States
(12) Patent Application Publication
(10) Pub. No.: US 2009/0308704 A1
(43) Pub. Date: Dec. 17, 2009

(54) Brake Pad Adapter Plate

(76) Inventor: Kevin Alexander, Brislington (GB)

Correspondence Address: BOYLE FREDRICKSON S.C., 840 North Plankinton Avenue, MILWAUKEE, WI, 53203, US

(21) Appl. No.: 12/140,794

(22) Filed: Jun. 17, 2008

(51) Int. Cl. F16D 65/04

(52) U.S. Cl. 188/243

(57) ABSTRACT

A brake pad adapter plate 2 has a rear surface having a mounting bracket provided thereon by means of which, in use, the adapter plate 2 is attached to a braking arm 5 of a braking system. A front surface has a dovetail groove 15 extending longitudinally therealong from the bottom end 2b of the plate 2 towards but terminating short of the top end 2a, by means of which, in use, a friction material 3 having a complementary dovetail tongue formed on a fastening surface thereon is attached to said front surface. A through opening 16 is formed in the adapter plate 2 proximate to the bottom end 2b and extending from rear surface to the front surface intersecting the dovetail groove 15, and a locking plate 20 is mounted on the rear surface so as to engage in said through opening 15. The locking plate 20 is moveable between an extended position in which the locking plate 20 extends into the dovetail groove 15 and a retracted position in which the locking plate 20 is withdrawn from the dovetail groove 15, and a spring clip 21 is associated with locking plate to restrain the locking plate 20 the extended or retracted position.

The present invention relates to brake pads for disc type brakes and more particularly to adapter plates for use with such brake pads.

Disc-type braking systems comprising a disc which is rotationally fast with one or more wheels and a brake pad having a friction material which is pressed against a circular face of the disc in order to slow the rotational movement thereof are well known in the art and used in a wide variety of applications. One such application is in braking systems for trains. A prior art such train system uses a brake pad comprising a backing plate with a friction material non-removable fastened to one side thereof. The brake pad is attached to a support plate by means of spring clips which pass through holes formed in pins which protrude from the support plate. The support plate hangs on a mounting plate so as to engage against one side thereof. The mounting plate, in turn, has a mounting hole formed on a side remote from the support plate which is sized to receive a mounting pin formed on the end of an actuated braking arm, the whole assembly being suspended on the pin under its own weight so as to be pivotally moveable about the axis of the mounting pin. A locking pin engages through a transverse hole formed on the top of the mounting pin so as to prevent unintentional removal of the mounting bracket from the braking arm.

Upon operation of the brake, the braking arm is pressed towards the brake disc, pressing the friction material against the braking surface of the disc, the pad pivoting on the arm about the axis of the mounting pin in order to ensure that the friction surface engages flatly against the disc and hence wears evenly.

The prior art system has the drawback, however, that due to the braking forces which are involved in stopping a train, the support plate must be made to withstand significant loads and as a result is very heavy. In order to change the friction material, the mounting plate is first pivoted away from the brake disc. The whole assembly must then be lifted off of the braking arm in order to allow access to the spring clips which retain the brake pad on the support plate. The mounting plate is then separated from the support plate. The spring clips are then released, allowing removal of the old brake pad and replacement with new, before the system is re-assembled. Due to the procedure and weight of the parts, replacing of these prior art pads is therefore a two man job which takes a significant amount of time. Moreover, the location of the spring clips between separate segments of friction material makes them susceptible to possible contact with the brake disc if the friction material wears excessively, possibly leading to wear of the brake disc and/or braking of the spring clips, allowing the friction material to drop off the backing plate during use. There is, therefore, a need for a pad arrangement which simplifies the pad replacement operation to a point where is can be carried out by a single person in just a short period of time.

According to the present invention there is provided a brake pad adapter plate comprising a rear surface having a mounting bracket provided thereon by means of which, in use, the adapter plate is attached to a braking arm of a braking system, and a front surface having one part of a two part elongated complementary coupling system extending longitudinally therealong from one end of the plate towards an opposing end, by means of which, in use, a friction material having the other part of the two part elongated coupling system formed on a fastening surface thereon is attached to said front surface, and locking means located proximate to said one end of the plate which is removably engageable into said one part of the coupling system so as to cause an obstruction therein which, in use, prevents release of the friction material from the plate.

A brake pad adapter plate in accordance with the invention has the advantage that the friction material can be removed and replaced much more easily due to the fact that adapter plate stays in place attached to the brake arm and is therefore fully supported during the whole procedure. A single user can therefore replace the friction material by simply operating the locking means to retracted it from obstructing the coupling system, allowing the friction material to be removed from the adapter plate and replacement inserted. The replacement material can then be held in place with one hand while the locking means operated with the other to move it back into engagement in the coupling system, thereby locking the replacement material in place.

More particularly, the present invention provides a brake pad adapter plate comprising a rear surface having a mounting bracket provided thereon by means of which, in use, the adapter plate is attached to a braking arm of a braking system, and a front surface having a dovetail groove extending longitudinally therealong from one end of the plate towards but terminating short of an opposing end, by means of which, in use, a friction material having a complementary dovetail tongue formed on a fastening surface thereon is attached to said front surface, a through opening formed in the adapter plate proximate to said one end and extending from rear surface to the front surface intersecting the dovetail groove, and a locking locking plate mounted on the rear surface so as to engage in said through opening and being moveable therein between an extended position in which the locking plate extends into the dovetail groove and a retracted position in which the locking plate is withdrawn from the dovetail groove, biasing means being associated with locking plate to restrain the locking plate at least in the extended position.

The present invention still further provides a method of changing a friction surface of a brake pad adapter plate having a rear surface with a mounting bracket provided thereon by means of which, in use, the adapter plate is attached to a braking arm of a braking system, and a front surface having a dovetail groove extending longitudinally therealong from one end of the plate towards but terminating short of an opposing end, by means of which, in use, a friction material having a complementary dovetail tongue formed on a fastening surface thereon is attached to said front surface, a through opening formed in the adapter plate proximate to said one end and extending from rear surface to the front surface intersecting the dovetail groove, and a locking locking plate mounted on the rear surface so as to engage in said through opening and being moveable therein between an extended position in which the locking plate extends into the dovetail groove and a retracted position in which the locking plate is withdrawn from the dovetail groove, biasing means being associated with locking plate to restrain the locking plate at least in the extended position., comprising the steps of: moving the adapter plate away from a brake disc with which it is used; moving the locking plate from its extended position to its retracted position in order to remove the obstruction from the dovetail groove; sliding the friction material longitudinally along the adapter plate towards the one end so as to slide the dovetail tongue formed thereon out of the dovetail groove; engaging the dovetail tongue of replacement friction material into the dovetail groove at said one end of the adapter plate and sliding towards the other end past the through opening; and moving the locking plate from the retracted position back into its extended position so as to obstruct the dovetail groove, thereby retaining the replacement friction lining in place.

In order that the invention may be well understood, there will now be described an embodiment thereof, given by way of example, reference being made to the accompanying drawings, in which:

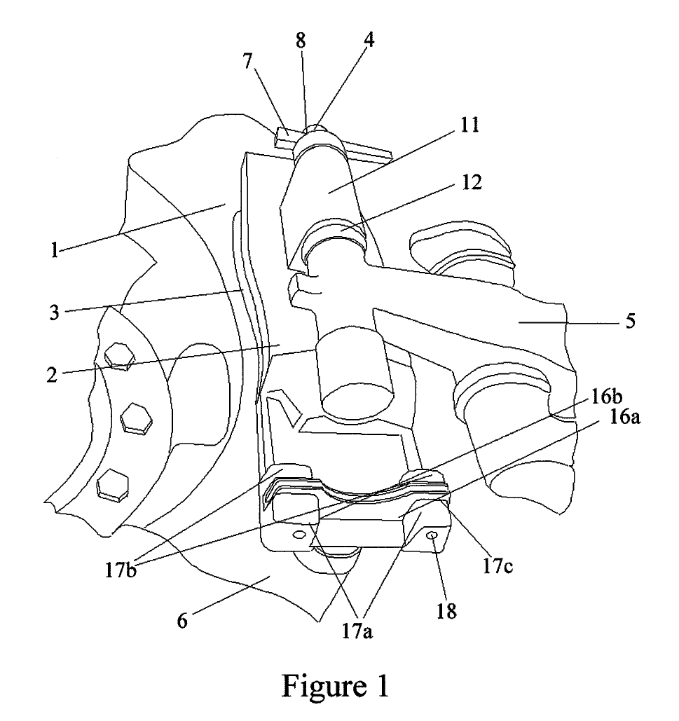

FIG. 1 is a perspective view of a braking assembly incorporating an adapter plate according to the invention;

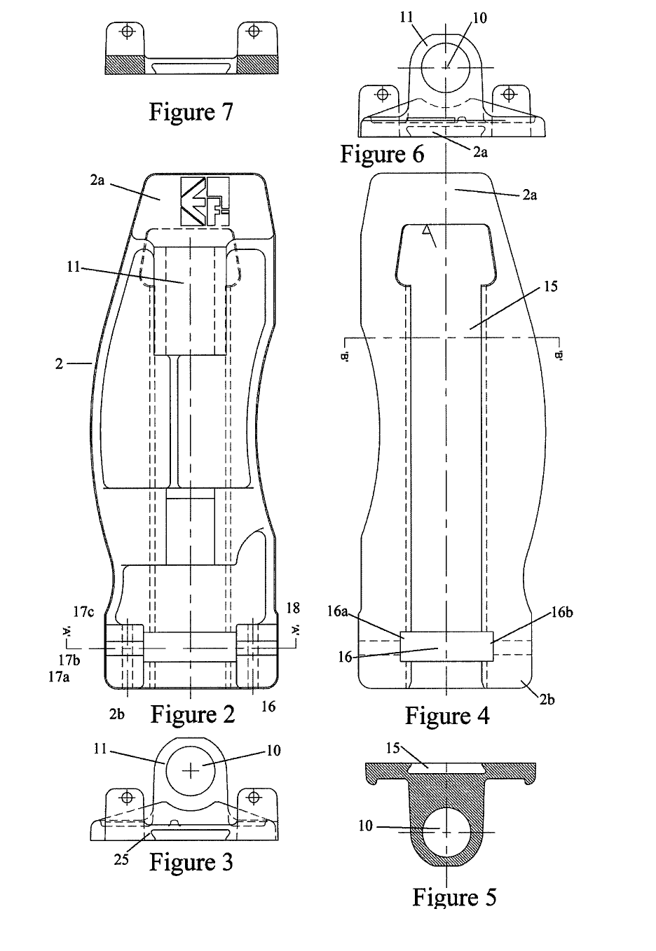

FIG. 2 is a rear view of the adapter plate of the invention;

FIG. 3 is a bottom view of the adapter plate of FIG. 2;

FIG. 4 is a front view of the adapter plate of FIG. 2;

FIG. 5 is a section view of the adapter plate taken on B-B of FIG. 4;

FIG. 6 is a top view of the adapter plate of FIG. 2;

FIG. 7 is a section view of the adapter plate taken on A-A of FIG. 2;

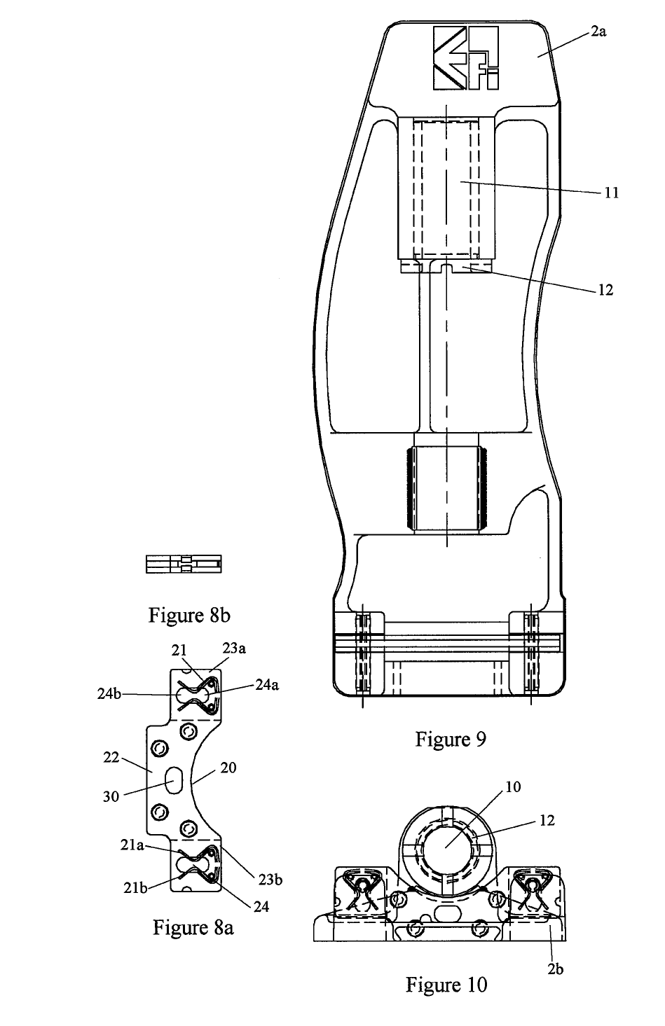

FIG. 8a is a front view of a locking plate which works with the adapter plate of FIG. 2;

FIG. 8b is a side view of the locking plate of FIG. 8a;

FIG. 9 is a rear view of the adapter plate of FIG. 2 with the locking plate assembled therein; and

FIG. 10 is a bottom view of the adapter plate of FIG. 2 with the locking plate assembled therein.

Referring first to FIG. 1, there is shown a brake pad assembly 1 which incorporates an adapter plate 2 of the invention with friction material 3 mounted thereon, the assembly 1 being mounted on the mounting pin 4 of a braking arm 5 of a braking system, which, upon actuation of the brake, is pressed towards the brake disc 6 so as to press the braking surface of the friction material 3 against the disc 6 to impart a braking force thereto.

As shown in more detail in FIGS. 2 to 7, the adapter plate 2 has a cylindrical through opening 10 formed in block 11 which extends from the back surface of the plate 2 proximate to the top 2a thereof. The opening 10 extends towards the bottom end 2b of the plate 1 and is sized to receive a bushing 12 (shown in FIG. 9), which, in turn, has a cylindrical opening therein which is sized to receive, in use, the mounting pin 4 of the braking arm 5 is a manner which allows the plate 2 to pivot about the axis of the pin 4. In this way, the plate 2 is pivotally mountable on the mounting pin 4, a locking pin 7 being engageable in a transverse opening 8 formed in the end of the pin 7 so as to lock the plate 2 onto the pin 4.

An arcuate recess 13 is formed in the back surface of the plate 2 spaced apart from the bottom of the block 11 in which the opening 10 is formed towards the bottom of the plate 2. The curvature of the recess 13 is sized to complement the curvature of the outer surface of cylindrical guide block 9 formed on the end of the braking arm 4 in axial alignment with the mounting pin 4, the engagement of the guide block 9 in the recess 13 operating to prevent the pad skewing on the pin 4 during use.

The front surface of the plate 2, which, in use, faces the braking surface of the disc 6, as a dovetail slot 15 formed therein which opens to the bottom 2b of the plate 2 and extends longitudinally from the bottom 2b towards but terminates short of the top 2a of the plate 2.

A through opening 16 extends through the plate 2 proximate to the bottom 2b thereof, intersecting the dovetail slot 15 proximate to the bottom 2b as shown in FIG. 4. Each end 16a, 16b of the through opening 16 is bounded by a pair of longitudinally spaced apart posts 17a, 17b, the gap 17c between each pair of posts 17a, 17b being equal in longitudinal width to and in longitudinal alignment with the through opening 16. A longitudinal hole 18 is formed in each post 17a, 17b, the holes in each pair of posts 17a, 17b being aligned so that a retaining pin 19 is engageable therein to extend across the gap 17c.

FIGS. 8a and 8b show a locking plate 20 which is engageable in the through opening so as to extend into the dovetail slot as described hereinafter. The plate is formed by a pair of plate members 20a, 20b which are of identical shape, shown in FIG. 8a, and which are riveted together in spaced apart relation so as to form a space in which locking springs 21 can be located. The thickness of the locking plate 20 is sized to be a clearance fit in the through opening 16.

The locking plate has a central tab 22, the width of which is a clearance fit with the lateral width of the through opening 16 so as to be engageable therethrough, and a pair of wings 23a, 23b, one on either side of the tab 22 which increase the width of the locking plate 20 at a point spaced from the bottom of the tab 22 to a size which is bigger than the lateral width of the through opening 16, thereby limiting the distance the tab 22 can extend through the plate 2.

Each wing has an elongated through opening 24 formed therein in which is engageable the retaining pin 19 of one of the pair of post 17a, 17b such that the pin is moveable along the through opening to permit limited movement of the locking plate 20 relative to the pins 19. A locking spring 21 in the formed of a spring clip is located in each wing 23a, 23b of the locking plate 20, the spring arms 21a, 21b of each locking spring 21 engaging laterally into the through opening 24 of its associated wing 23a, 23b so as to divide the through opening 24 longitudinally into two regions 24a, 24b, each of which is sized to receive the pin 19, the spring arms 21a, 21b operating to retain the pin in either region 24a, 24b and hence retain the plate 20 in a corresponding position relative to the adapter plate 2, the arms 21a, 21b resiliently deforming upon application of sufficient force to allow each pin to move past the arms into the other region 24b, 24a and hence into a second position relative to the adapter plate 2.

The adapter plate 2 operates as follows:

The adapter plate 2 is mounted on the braking arm 5 in a conventional manner described above and locked in place by the locking pin 7. The locking plate is located with its central tab 22 engaged in through opening and the wings 23a, 23b located being the respective pairs of post 17a, 17b, and the pin 19 is inserted through the holes 18 in each pair of posts 17a, 17b, extending through the elongated opening 24 in the associated wing 23a, 23b so as to secure the locking plate 20 to the adapter plate 2. The locking plate 20 is then pulled away from the adapter plate so that the pins 19 move into the lower region 24b in the through opening 24 in each wing 23a, 23b and the central tab 22 is raised into a retracted position in which it is fully withdrawn from the dovetail slot 15, allowing insertion of a complementary dovetail projection into the slot 15 from the bottom 2b of the adapter plate 2.

One or more pieces of friction material with the complementary dovetail projection formed on the rear surface thereof are then attached to the adapter plate 2 by sliding the dovetail projection into the dovetail slot 15 through the open bottom end, the blind top end of the dovetail slot 15 limiting the upward travel of the friction material along the adapter plate 2.

Once the friction material is in position, the locking plate 20 is then pressed back towards the adapter plate 2 with sufficient force to cause the pins 19 to urge the spring arms 21a, 21b outwards allowing them to move from the lower region 24a into the upper region 24a. The tab 22 is accordingly moved from the retracted position into an extended position in which it projects into the dovetail slot 15, obstructing the travel of a dovetail projection therealong and hence securing the previously inserted friction material in position on the adapter plate. The pad 1 is then ready for use.

When the friction material has reached its wear limit, it is replaced simply by first pulling the braking arm 5 away from the disc so as to create a clearance between the surface of the friction material 3 and the disc. The locking plate 20 is then moved into its retracted position—this can be achieved, for example, by inserting a suitable lever into a lever opening 30 formed in the back of the locking plate 20. With the tab 22 retracted from the dovetail slot 15, the worn friction material 3 will simply drop down the dovetail slot 15 under its own weight and fall out the bottom 2b of the adapter plate 2.

The dovetail projection of the replacement friction material 3 is then slid into the dovetail slot 15 from the bottom end 2b of the adapter plate 2, after which the locking plate 20 is moved back to its engaged position so that the tab 22 secures the new friction material in place.

Since it is only the friction material which is replaced and not the whole pad, it will be seen that the whole operation is much easier than the prior art approach as the friction material is generally very light. Furthermore, because the friction material is slid into position from the one end of the pad, only minimal movement of the braking arm away from the disc is necessary in order to enable replacement of the friction material. It will therefore be understood that the whole operation can be carried out very quickly by just one person.

It will be understood that the locking plate arrangement as described above may be replaced by other latching systems within the scope of the invention. For example, a rotating locking plate may be used which is pivotally moved between a retracted and an engaged position, a latching pin which is biased into an engaged position may be provided in the plate or the like.

1. A brake pad adapter plate comprising a rear surface having a mounting bracket provided thereon by means of which, in use, the adapter plate is attached to a braking arm of a braking system, and a front surface having one part of a two part elongated complementary coupling system extending longitudinally therealong from one end of the plate towards an opposing end, by means of which, in use, a friction material having the other part of the two part elongated coupling system formed on a fastening surface thereon is attached to said front surface, and locking means located proximate to said one end of the plate which is removably engageable into said one part of the coupling system so as to cause an obstruction therein which, in use, prevents release of the friction material from the plate.

2. An adapter plate according to claim 1, wherein the two part coupling system comprises a dovetail groove and a complementary dovetail tongue.

3. An adapter plate according to claim 2, wherein the dovetail groove is formed on the front surface of the plate and extends from said one end of the plate towards but terminates short of said other end.

4. An adapter plate according to claim 3, wherein said one end is an end which, in use, forms a bottom end of the plate.

5. An adapter plate according to claim 1, wherein the locking means comprises a latch member which is moveable between an extended position in which it engages into said one part of the coupling system and a retracted position in which the latch member is withdrawn from said one part of the coupling system so as to enable release and replacement of the friction material, and further including biasing means which biases the latch member into the extended position.

6. An adapter plate according to claim 5, wherein the biasing means is an over-centre system which restrains the latch member in either the extended or the retracted positions.

7. An adapter plate according to claim 6, wherein the biasing means comprises at least one resiliently deformable member which extends into a path of travel associated with the movement of the latch member between the extended and the retracted positions so as prevent movement of the latch member upon a predefined movement force is applied thereto sufficient to overcome the loading of the resiliently deformable member.

8. An adapter plate according to claim 7, wherein the resiliently deformable member is at least one leg of a spring clip which extends into the middle of a slot in the latch member along which a pin provided on the adapter plate moves upon movement of the latch member between the retracted and extended positions.

9. An adapter plate according to claim 5, wherein the latch member has at least one through slot formed therein and engages in a through opening formed in the adapter plate so as to extend from the rear surface to the front surface, intercepting the one part of the coupling system, the rear surface of the adapter plate including a pin engaged with the or each through slot of the latch member so as to limit the movement of the latch member relative to the adapter plate.

10. An adapter plate according to claim 9, wherein the latch member is a locking plate which is oriented transversely to the elongated complementary coupling system.

11. An adapter plate according to claim 10, wherein the locking plate has a first section having a first width which is a clearance fit in the through opening formed in the adapter plate and which, in the extended position, extends into said one part of the coupling system, and a second section having a second width which is larger than the width in the opening formed in the adapter plate so as to prevent the locking plate moving completely through the opening, two slots being formed in the second section of the locking plate, one on either side of the first section, each slot receiving an associated pin mounted in the adapter plate.

12. An adapter plate according to claim 11, wherein a spring clip is mounted to the locking plate in the region of each slot, the arms of which extend into the slot between opposing ends thereof so as to form a constriction which prevents movement of the associated pin there along until the movement force exceeds a predetermined level.

13. An adapter plate according to claim 1, wherein the mounting bracket is a longitudinally extending tubular opening in which, in use, is received a mounting pin of the braking arm.

14. A brake pad adapter plate comprising a rear surface having a mounting bracket provided thereon by means of which, in use, the adapter plate is attached to a braking arm of a braking system, and a front surface having a dovetail groove extending longitudinally therealong from one end of the plate towards but terminating short of an opposing end, by means of which, in use, a friction material having a complementary dovetail tongue formed on a fastening surface thereon is attached to said front surface, a through opening formed in the adapter plate proximate to said one end and extending from rear surface to the front surface intersecting the dovetail groove, and a locking locking plate mounted on the rear surface so as to engage in said through opening and being moveable therein between an extended position in which the locking plate extends into the dovetail groove and a retracted position in which the locking plate is withdrawn from the dovetail groove, biasing means being associated with locking plate to restrain the locking plate at least in the extended position.

15. A method of changing a friction surface of a brake pad adapter plate according to claim 14, comprising the steps of:
moving the adapter plate away from a brake disc with which it is used;
moving the locking plate from its extended position to its retracted position in order to remove the obstruction from the dovetail groove;
sliding the friction material longitudinally along the adapter plate towards the one end so as to slide the dovetail tongue formed thereon out of the dovetail groove;
engaging the dovetail tongue of replacement friction material into the dovetail groove at said one end of the adapter plate and sliding towards the other end past the through opening; and
moving the locking plate from the retracted position back into its extended position so as to obstruct the dovetail groove, thereby retaining the replacement friction lining in place.
